(19) United States
(12) Patent Application Publication
(10) Pub. No.: US 2024/0276485 A1
(43) Pub. Date: Aug. 15, 2024

(54) DUPLEX MODE SWITCHING BASED AT LEAST IN PART ON AN INDICATION OF A SKIPPED UPLINK OCCASION

(71) Applicant: QUALCOMM Incorporated, San Diego, CA (US)

(72) Inventors: Huilin XU, Temecula, CA (US); Muhammad Sayed Khairy ABDELGHAFFAR, San Jose, CA (US); Ahmed Attia ABOTABL, San Diego, CA (US); Abdelrahman Mohamed Ahmed Mohamed IBRAHIM, San Diego, CA (US)

(21) Appl. No.: 18/168,981

(22) Filed: Feb. 14, 2023

(51) Int. Cl. H04W 72/1268; H04L 5/16; H04W 72/23

(52) U.S. Cl. CPC H04W 72/1268; H04L 5/16; H04W 72/23

(57) ABSTRACT

Various aspects of the present disclosure generally relate to wireless communication. In some aspects, a user equipment (UE) may transmit an indication that a physical uplink shared channel occasion that at least partially overlaps with resources associated with a downlink communication will not be used to transmit an uplink transmission. The UE may switch from operating in a full duplex mode to operating in a half duplex mode based at least in part on transmitting the indication. The UE may receive the downlink communication while operating in the half duplex mode. Numerous other aspects are described.

### FIELD OF THE DISCLOSURE

Aspects of the present disclosure generally relate to wireless communication and to techniques and apparatuses for duplex mode switching based at least in part on an indication of a skipped uplink occasion.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting an indication that a physical uplink shared channel (PUSCH) occasion that at least partially overlaps with resources associated with a downlink communication will not be used to transmit an uplink transmission. The method may include switching from operating in a full duplex (FD) mode to operating in a half duplex (HD) mode based at least in part on transmitting the indication. The method may include receiving the downlink communication while operating in the HD mode.

Some aspects described herein relate to a method of wireless communication performed by a network node. The method may include receiving, from a UE, an indication that a PUSCH occasion that at least partially overlaps with resources associated with a downlink communication will not be used to transmit an uplink transmission. The method may include switching from operating in an FD mode to operating in an HD mode based at least in part on receiving the indication. The method may include transmitting, to the UE, the downlink communication while operating in the HD mode.

Some aspects described herein relate to a UE for wireless communication. The UE may include a memory and one or more processors coupled to the memory. The one or more processors may be configured to transmit an indication that a PUSCH occasion that at least partially overlaps with resources associated with a downlink communication will not be used to transmit an uplink transmission. The one or more processors may be configured to switch from operating in an FD mode to operating in an HD mode based at least in part on transmitting the indication. The one or more processors may be configured to receive the downlink communication while operating in the HD mode.

Some aspects described herein relate to a network node for wireless communication. The network node may include a memory and one or more processors coupled to the memory. The one or more processors may be configured to receive, from a UE, an indication that a PUSCH occasion that at least partially overlaps with resources associated with a downlink communication will not be used to transmit an uplink transmission. The one or more processors may be configured to switch from operating in an FD mode to operating in an HD mode based at least in part on receiving the indication. The one or more processors may be configured to transmit, to the UE, the downlink communication while operating in the HD mode.

Some aspects described herein relate to a non-transitory computer-readable medium that stores a set of instructions for wireless communication by a UE. The set of instructions, when executed by one or more processors of the UE, may cause the UE to transmit an indication that a PUSCH occasion that at least partially overlaps with resources associated with a downlink communication will not be used to transmit an uplink transmission. The set of instructions, when executed by one or more processors of the UE, may cause the UE to switch from operating in an FD mode to operating in an HD mode based at least in part on transmitting the indication. The set of instructions, when executed by one or more processors of the UE, may cause the UE to receive the downlink communication while operating in the HD mode.

Some aspects described herein relate to a non-transitory computer-readable medium that stores a set of instructions for wireless communication by a network node. The set of instructions, when executed by one or more processors of the network node, may cause the network node to receive, from a UE, an indication that a PUSCH occasion that at least partially overlaps with resources associated with a downlink communication will not be used to transmit an uplink transmission. The set of instructions, when executed by one or more processors of the network node, may cause the network node to switch from operating in an FD mode to operating in an HD mode based at least in part on receiving the indication. The set of instructions, when executed by one or more processors of the network node, may cause the network node to transmit, to the UE, the downlink communication while operating in the HD mode.

Some aspects described herein relate to an apparatus for wireless communication. The apparatus may include means for transmitting an indication that a PUSCH occasion that at least partially overlaps with resources associated with a downlink communication will not be used to transmit an uplink transmission. The apparatus may include means for switching from operating in an FD mode to operating in an HD mode based at least in part on transmitting the indication. The apparatus may include means for receiving the downlink communication while operating in the HD mode.

Some aspects described herein relate to an apparatus for wireless communication. The apparatus may include means for receiving, from a UE, an indication that a PUSCH occasion that at least partially overlaps with resources associated with a downlink communication will not be used to transmit an uplink transmission. The apparatus may include means for switching from operating in an FD mode to operating in an HD mode based at least in part on receiving the indication. The apparatus may include means for transmitting, to the UE, the downlink communication while operating in the HD mode.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4C are diagrams illustrating examples of full duplex (FD) communication, in accordance with the present disclosure.

FIG. 5 is a diagram illustrating examples of FD communication in a wireless network, in accordance with the present disclosure.

FIG. 6 is a diagram of an example associated with duplex mode switching based at least in part on an indication of a skipped uplink occasion, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In some examples, a communication link between a network node and a user equipment (UE) may switch between full duplex (FD) and half duplex (HD) operations depending on scheduling, configuration, and/or triggering of transmissions and receptions at the UE by the network node. For example, when an uplink and downlink communication are configured and/or scheduled in a same set of symbols, the network node and/or the UE may operate in an FD mode. However, if only one of an uplink communication or a downlink communication is configured and/or scheduled in a set of symbols, the communication may be performed in an HD mode.

In some examples, communicating in an FD mode may result in more communication errors and/or resource consumption than communicating in an HD mode. This may be because a network node and/or a UE may need to use different transmission configuration indicator (TCI) states and/or beams for uplink and downlink transmissions while communicating in an FD mode, and thus communications may not occur using the best beam for at least one of the uplink or downlink communications. Moreover, operating in the FD mode may require high power and/or other resource consumption at the network node and/or UE because two links (e.g., transmission and reception) may need to be maintained by the corresponding device. In some examples, a UE configured to operate in an FD mode (e.g., a UE scheduled with an uplink resource or occasion that at least partially overlaps with a downlink communication) may not have data to transmit and/or may otherwise skip an uplink transmission or occasion. However, because the downlink communication was configured for reception in an FD mode, the network node and/or the UE may still operate in an FD mode to transmit and receive the downlink communication. This may result in unnecessarily high resource consumption and/or communication errors associated with utilizing less than ideal beam states and other communication parameters for the downlink communication.

Some techniques and apparatuses described herein enable signaling of an indication that an uplink occasion associated with an FD set of symbols will be skipped by a UE, and thus switching, by the UE and/or a network node, from operating in an FD mode to operating in an HD mode. In some aspects, when a UE intends to skip an uplink occasion (e.g., a physical uplink shared channel (PUSCH) occasion) that at least partially overlaps with resources associated with a downlink communication, the UE may transmit an indication to the network node indicating that the uplink occasion will not be used to transmit an uplink transmission. Accordingly, based at least in part on the indication, the network node and/or the UE may switch from operating in an FD mode to operating in an HD mode, and then communicate the downlink communication while operating in the HD mode. Switching from the FD mode to the HD mode may result in more efficient usage of power and network resources by the respective devices implementing HD parameters rather than FD parameters for communicating the downlink communication. Switching from the FD mode to the HD mode may also result in reduced communication errors because ideal beam states and other communication parameters may be used for the downlink communication, thereby leading to reduced power, computing, and network resource consumption that may otherwise be required for correcting communication errors.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

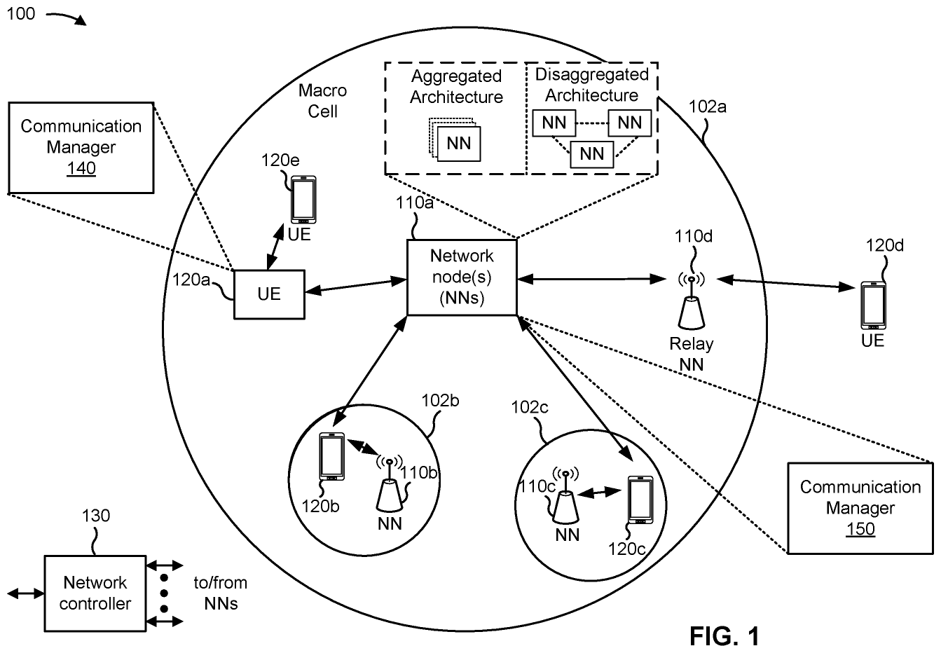

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication that a PUSCH occasion that at least partially overlaps with resources associated with a downlink communication will not be used to transmit an uplink transmission; switch from operating in an FD mode to operating in an HD mode based at least in part on transmitting the indication; and receive the downlink communication while operating in the HD mode. Additionally, or alternatively, the communication manager 140 may perform one or more other operations described herein.

In some aspects, the network node 110 may include a communication manager 150. As described in more detail elsewhere herein, the communication manager 150 may receive, from a UE, an indication that a PUSCH occasion that at least partially overlaps with resources associated with a downlink communication will not be used to transmit an uplink transmission; switch from operating in an FD mode to operating in an HD mode based at least in part on receiving the indication; and transmit, to the UE, the downlink communication while operating in the HD mode. Additionally, or alternatively, the communication manager 150 may perform one or more other operations described herein.

As indicated above, FIG. 1 is provided as an example. Other examples may differ from what is described with regard to FIG. 1.

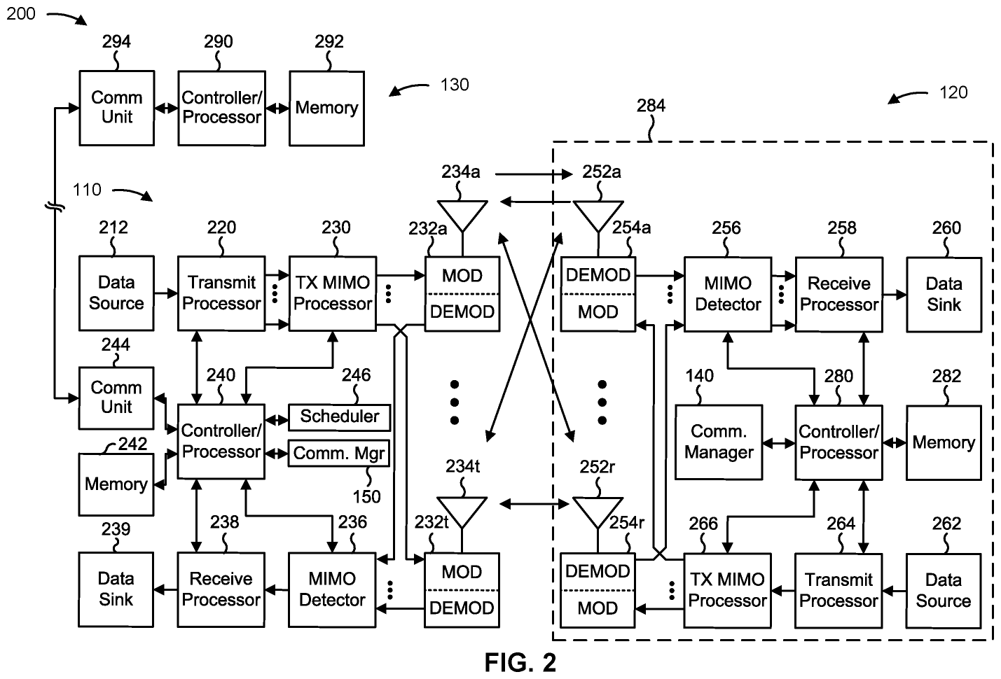

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

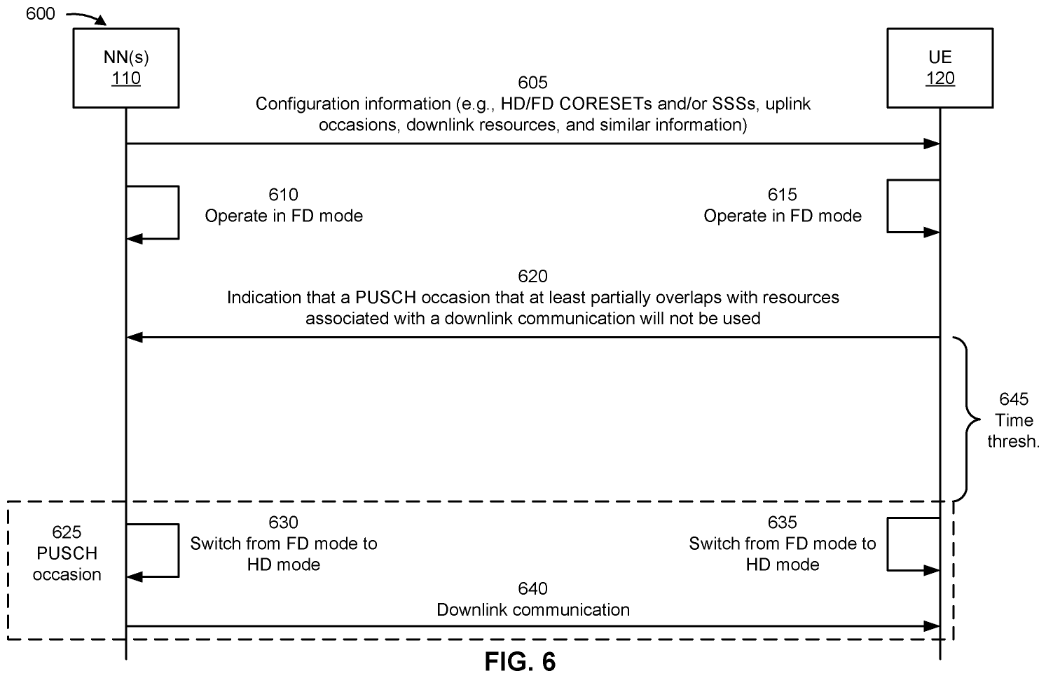

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

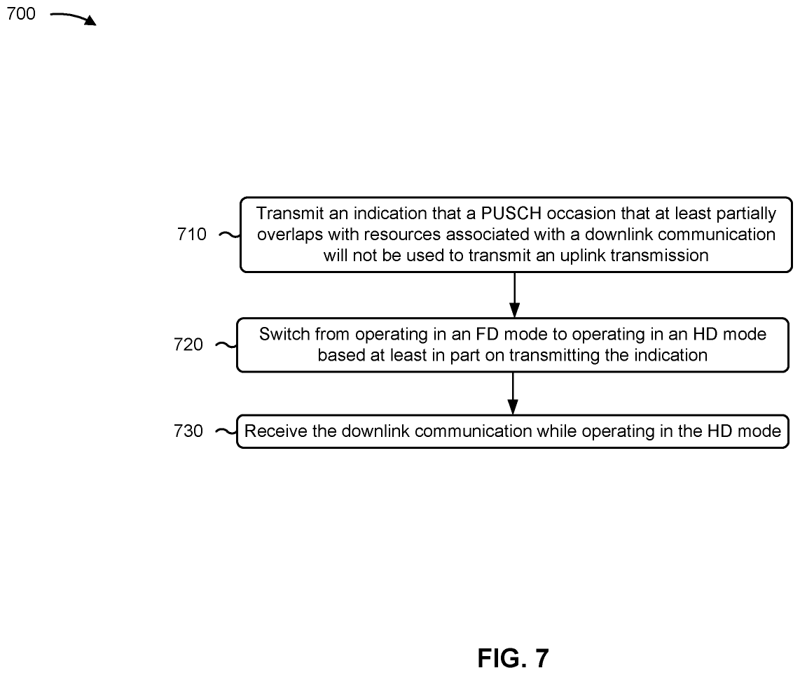

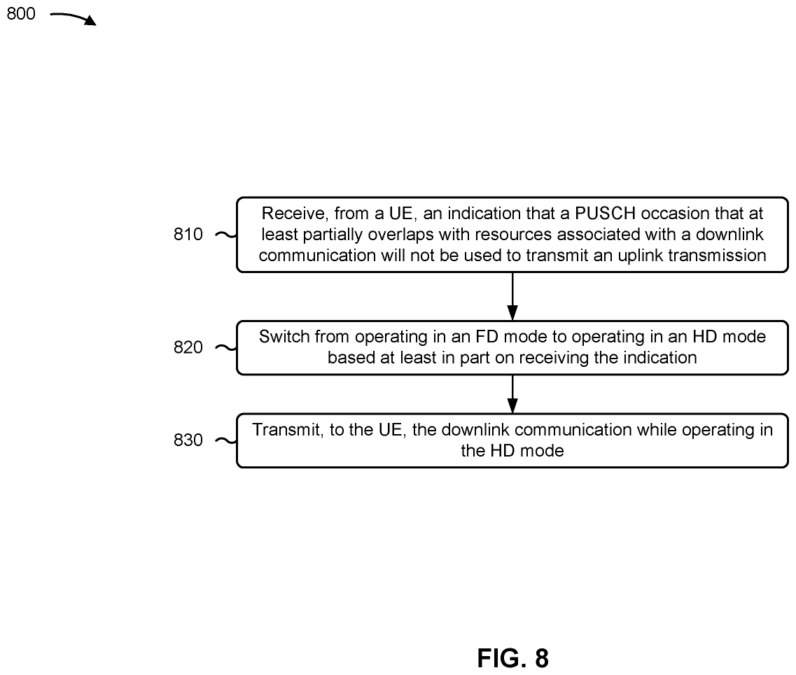

The controller/processor 240 of the network node 110, the controller/processor 280 of the UE 120, and/or any other component(s) of FIG. 2 may perform one or more techniques associated with duplex mode switching based at least in part on an indication of a skipped uplink occasion, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting an indication that a PUSCH occasion that at least partially overlaps with resources associated with a downlink communication will not be used to transmit an uplink transmission; means for switching from operating in an FD mode to operating in an HD mode based at least in part on transmitting the indication; and/or means for receiving the downlink communication while operating in the HD mode. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from a UE, an indication that a PUSCH occasion that at least partially overlaps with resources associated with a downlink communication will not be used to transmit an uplink transmission; means for switching from operating in an FD mode to operating in an HD mode based at least in part on receiving the indication; and/or means for transmitting, to the UE, the downlink communication while operating in the HD mode. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

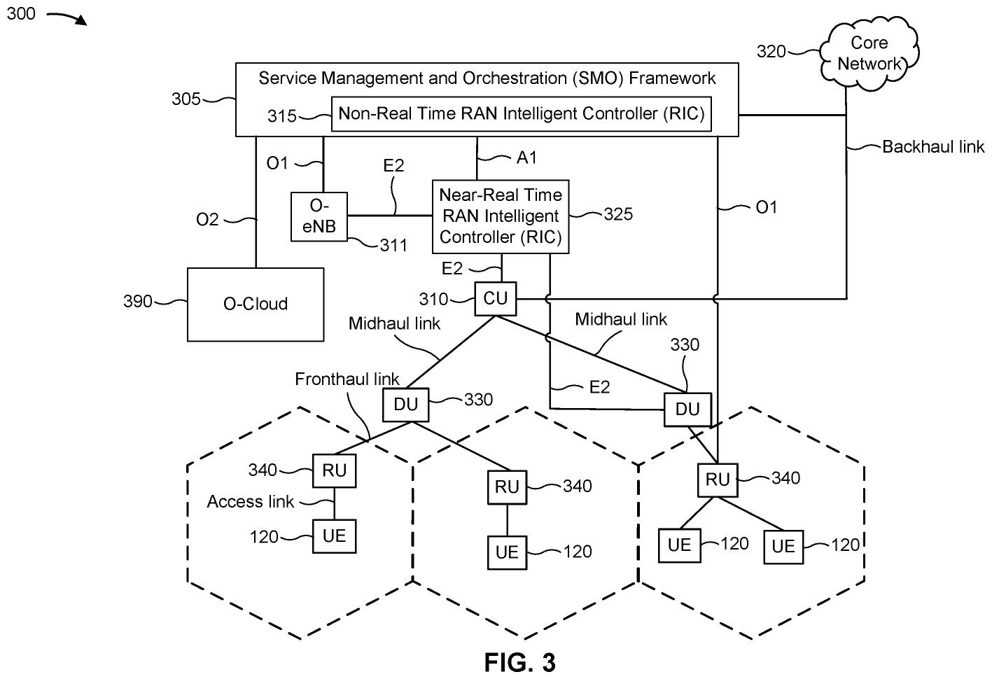

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface).

For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325.

The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

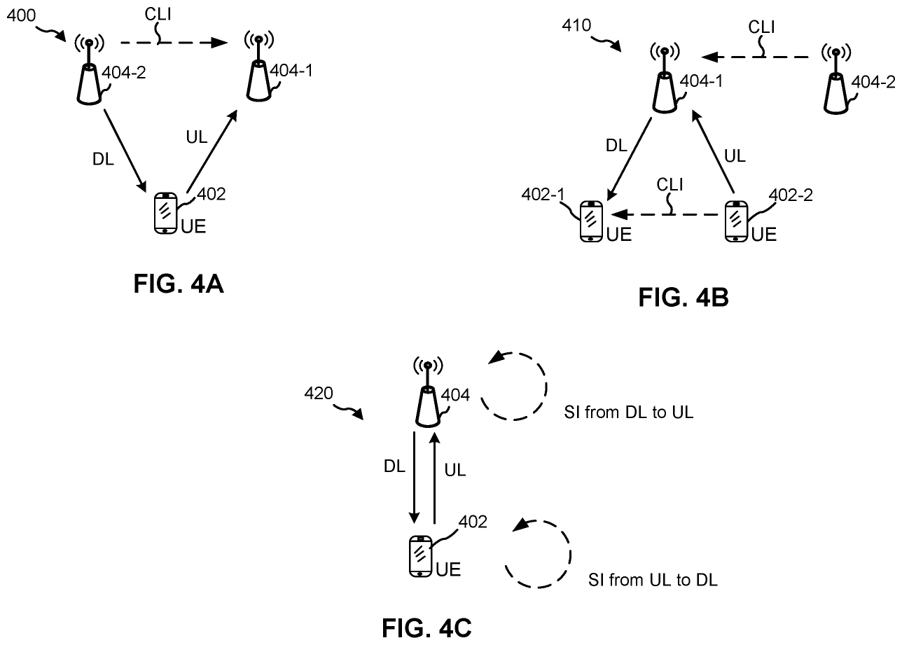

FIGS. 4A-4C are diagrams illustrating examples 400, 410, 420 of FD communication, in accordance with the present disclosure. “FD communication” in a wireless network refers to simultaneous bi-directional communication between devices in the wireless network. For example, a UE operating in an FD mode may be capable of transmitting an uplink communication and receiving a downlink communication at the same time (e.g., in the same slot or the same symbol). “HD communication” in a wireless network refers to unidirectional communications (e.g., only downlink communication or only uplink communication) between devices at a given time (e.g., in a given slot or a given symbol).

An FD communication may utilize overlapped time resources at a single node (such as a UE or a network entity, such as a TRP, a network node 110, a CU 310, a DU 330, or an RU 340) for transmission and reception. For example, a UE or a network entity may perform a transmission and a reception using the same time resources, such as via frequency division multiplexing (FDM) or spatial division multiplexing (SDM). “FDM” refers to performing two or more communications using different frequency resource allocations. “SDM” refers to performing two or more communications using different spatial parameters, such as different TCI states corresponding to beams. An SDM communication can use overlapped time resources and frequency resources, and an FDM communication can use overlapped time resources and spatial resources (that is, overlapped beam parameters, TCI states, or the like). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi co-location (QCL) type. A QCL type may indicate one or more spatial parameters to be derived from the source signal. The source signal may be referred to as a QCL source. FD communications can include dynamic traffic (such as scheduled by downlink control information (DCI)) and/or semi-static traffic. Semi-static traffic is traffic associated with a semi-persistent resource, such as a semi-persistent scheduling (SPS) configured resource or a configured grant (CG).

The example 400 of FIG. 4A includes a UE 402 and two network nodes 404 (e.g., a first network node 404-1 and a second network node 404-2), wherein the UE 402 is sending uplink transmissions to the first network node 404-1 and is receiving downlink transmissions from the second network node 404-2. In the example 400 of FIG. 4A, FD is enabled for the UE 402, but not for the network nodes 404. Thus, the network nodes 404 are HD network entities.

The example 410 of FIG. 4B includes two UEs 402 (e.g., a first UE 402-1 and a second UE 402-2), and a first network node 404-1, wherein the first UE 402-1 is receiving a downlink transmission from the first network node 404-1 and the second UE 402-2 is transmitting an uplink transmission to the first network node 404-1. In the example 410 of FIG. 4B, FD is enabled for the first network node 404-1, but not for the first UE 402-1 and the second UE 402-2. Thus, the first UE 402-1 and the second UE 402-2 are HD UEs. The example 410 of FIG. 4B also includes a second network node 404-2, which may cause interference to the first network node 404-1, described in more detail below.

The example 420 of FIG. 4C includes a UE 402 and a network node 404, wherein the UE 402 is receiving a downlink transmission from the network node 404 and the UE 402 is transmitting an uplink transmission to the network node 404. In the example 420 of FIG. 4C, FD is enabled for both the UE 402 and the network node 404.

In the example 420 of FIG. 4C, the UE 402 and the network node 404 communicate using a beam pair. A beam pair may include a downlink beam and an uplink beam. For example, a UE 402 may use a beam pair that includes a downlink beam (that is, a receive beam) at the UE 402 and an uplink beam (that is, a transmit beam) at the UE 402 to communicate with the network node 404. The network node 404 may use a downlink beam (that is, a transmit beam) at the network node 404 to transmit communications received via the UE 402's downlink beam, and may use an uplink beam (that is, a receive beam) at the network node 404 to receive communications transmitted via the ULE 402's uplink beam.

In FIGS. 4A-4C, interference is indicated by dashed lines. Interference can occur between nodes of the same type (e.g., UE or network node) of examples 400, 410, 420 (referred to as “crosslink interference” (CLI)). Examples of CLI are shown in FIGS. 4A and 4B. In FIG. 4A, the second network node 404-2's downlink transmission interferes with the first network node 404-1's uplink transmission. In FIG. 4B, the first UE 402-1's uplink transmission interferes with the second UE 402-2's downlink transmission, and a downlink transmission of the second network node 404-2 interferes with the first network node 404-1's uplink transmission. In some cases, self-interference (SI) can occur. SI occurs when a node's transmission interferes with a reception operation of the node. For example, SI may occur due to reception by a receive antenna of radiated energy from a transmit antenna, cross-talk between components, or the like. Examples of SI at a UE 402 (from an uplink transmission to a downlink reception) and at a network node 404 (from a downlink transmission to an uplink reception) are shown in FD 4C. It should be noted that the above-described CLI and SI conditions can occur in FD deployments and in HD deployments.

As indicated above, FIGS. 4A-4C are provided as one or more examples. Other examples may differ from what is described with regard to FIGS. 4A-4C.

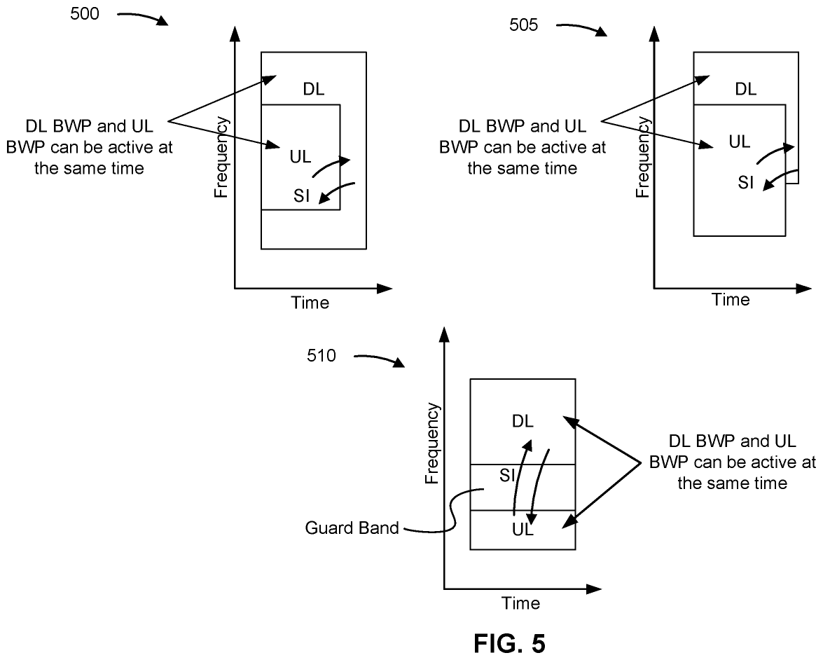

FIG. 5 is a diagram illustrating examples 500, 505, and 510 of FD communication in a wireless network, in accordance with the present disclosure.

As shown in FIG. 5, examples 500 and 505 show examples of in-band full-duplex (IBFD) communication. In IBFD, a UE may transmit an uplink communication to a network node and receive a downlink communication from the network node on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

As further shown in FIG. 5, example 510 shows an example of sub-band full-duplex (SBFD) communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

In some cases, SBFD may be subject to cross UL/DL interference due to the close frequency resource assignments for transmission and reception. Moreover, as shown in FIG. 5, SI of concurrent transmission/reception in the same carrier may occur in FD operation. In some examples, SI may refer to a signal energy from a transmission circuit leaking into the reception circuit and/or a signal energy from a transmission circuit interfering with the reception circuit due to reflection from the surrounding environment. In some cases, an FD device (e.g., a UE 120 or a network node 110 operating in an FD mode) may mitigate SI by measuring the SI and subtracting the SI from the reception branch at the device. In this regard, FD operation may be more complicated and resource-intensive than HD operation.

In some aspects, a communication link between a network node 110 and a UE 120 may switch between FD and HD operations depending on scheduling, configuration, and/or triggering of transmissions and receptions at the UE 120 by the network node 110. For example, when an uplink and downlink communication are configured and/or scheduled in a same set of symbols, the network node 110 and/or the UE 120 may operate in an FD mode. However, if only one of an uplink communication or a downlink communication is configured and/or scheduled in a set of symbols, the communication may be performed in an HD mode.

In some aspects, configured, scheduled, and/or triggered uplink and downlink communications may include higher-layer configured communications (e.g., CG uplink communications, SPS downlink communications), and/or dynamically scheduled and/or triggered channels and/or signals. Moreover, in order to achieve optimal performance in both FD modes and HD modes, a network node 110 may use duplex-mode dependent configurations for channels and/or signals. For example, the network node 110 may configure a control resource set (CORESET) and associated search space (SS) set to be FD or HD (e.g., the network node may configure a first CORESET and/or SS set associated with FD operation, and a second CORESET and/or SS sets associated with HD operation). In such examples, the UE 120 may only monitor the CORESET and/or SS set associated with the corresponding duplex mode that is active in the corresponding set of symbols. Additionally, or alternatively, the network node 110 may configure duplex-mode dependent TCI states for spatial filtering in HD or FD modes. In such examples, the UE 120 may transmit and/or receive according to a corresponding TCI state and/or corresponding TCI states for the duplex mode activated.

In some examples, operating in an FD mode may result in more communication errors and/or resource consumption that operating in an HD mode if there is only downlink communication or uplink communication. This may be because a network node 110 and/or a UE 120 may need to use different TCI states and/or beams for uplink and downlink transmissions, and thus communications in at least one direction may not occur on a best available beam. Moreover, operating in the FD mode may require high power and/or other resource consumption at the network node 110 and/or UE 120 because two distinct links (e.g., transmission and reception links) may need to be maintained by the corresponding device. However, in some examples, a UE 120 configured to operate in an FD mode (e.g., a UE 120 scheduled with an uplink resource or occasion that at least partially overlaps with a downlink communication) may not have data to transmit and/or may otherwise wish to skip an uplink transmission or occasion. Nonetheless, because the downlink communication was configured for reception in an FD mode (e.g., because the downlink communication is scheduled to take place in an FD set of symbols), the network node 110 and/or the UE 120 may operate in an FD mode to transmit and receive the downlink communication. This may result in unnecessarily high resource consumption to maintain FD and/or communication errors associated with utilizing less than ideal beam states and other communication parameters, thereby leading to high power, computing, and network resource consumption for correcting communication errors.

Some techniques and apparatuses described herein enable signaling of an indication that an uplink occasion associated with an FD set of symbols will be skipped by a UE 120, and thus switching, by the UE 120 and/or a network node 110, from operating in an FD mode to operating in an HD mode. In some aspects, when a UE 120 intends to skip an uplink occasion (e.g., a PUSCH occasion) that at least partially overlaps with resources associated with a downlink communication, the UE 120 may transmit an indication to the network node 110 indicating that the uplink occasion will not be used to transmit an uplink transmission. Accordingly, based at least in part on the indication, the network node 110 and/or the UE 120 may switch from operating in an FD mode to operating in an HD mode, and then communicate the downlink communication while operating in the HD mode. Switching from the FD mode to the HD mode may result in more efficient usage of power and network resources by the respective devices implementing HD parameters rather than FD parameters if only downlink communication occurs. Moreover, switching from the FD mode to the HD mode may result in reduced communication errors because ideal beam states and other communication parameters may be used for the downlink communication, thereby leading to reduced power, computing, and network resource consumption that may otherwise be required for correcting communication errors.

As indicated above, FIG. 5 is provided as an example. Other examples may differ from what is described with respect to FIG. 5.

FIG. 6 is a diagram of an example 600 associated with duplex mode switching based at least in part on an indication of a skipped uplink occasion, in accordance with the present disclosure. As shown in FIG. 6, a network node 110 (e.g., a CU, a DU, and/or an RU) may communicate with a UE 120. In some aspects, the network node 110 and the UE 120 may be part of a wireless network (e.g., wireless network 100). The network node 110 and the UE 120 may have established a wireless connection prior to operations shown in FIG. 6. In some aspects, the network node 110 and/or the UE 120 may be capable of operating in an FD mode, such as one of the FD modes described above in connection with FIGS. 4A-5.

As shown by reference number 605, the network node 110 may transmit, and the UE 120 may receive, configuration information. In some aspects, the UE 120 may receive the configuration information via one or more of RRC signaling, one or MAC control elements (MAC-CEs), and/or DCI, among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may indicate resources associated with uplink transmissions and/or downlink transmissions. For example, the configuration information may indicate CG occasions for use by the UE 120 to transmit uplink communications (e.g., PUSCH, PUCCH or SRS). Additionally, or alternatively, the configuration information may indicate resources and/or parameters associated with a pre-configured dynamic grant scheduled PUSCH occasion, which may be resources associated with a PUSCH occasion that is dynamically scheduled by the network node 110 without requiring reception of a corresponding scheduling request. Additionally, or alternatively, the configuration information may indicate resources and/or parameters associated with multiple PUSCH occasions scheduled by the same dynamic grant.

Moreover, the configuration information may indicate resources associated with downlink communications, such as SPS downlink resources or dynamic grant scheduled/triggered downlink resources. In some aspects, the resources associated with downlink communications may at least partially overlap with uplink resources, such as when a set of symbols are configured or scheduled for FD operation.

In some aspects, the configuration information may configure the UE 120 with parameters for operating in an HD mode and/or with other parameters for operating in an FD mode. For example, the configuration information may configure the UE 120 with one or more first bandwidth parts (BWPs) associated with HD transmission and/or reception, and one or more second BWPs associated with FD transmission and/or reception. Additionally, or alternatively, the configuration information may configure the UE 120 with one or more first timing advance values associated with HD transmission and/or reception, and one or more second timing advance values associated with FD transmission and/or reception. Additionally, or alternatively, the configuration information may configure the UE 120 with a first subcarrier spacing (SCS) associated with HD transmission and/or reception, and a second SCS associated with FD transmission and/or reception. Additionally, or alternatively, the configuration information may configure the UE 120 with a first polarization mode associated with HD transmission and/or reception, and a second polarization mode associated with FD transmission and/or reception.

In some aspects, the configuration information may configure HD-specific CORESETs and associated SS sets, or similar parameters, and/or FD-specific CORESETs and associated SS sets, or similar parameters. For example, the configuration information may indicate at least one of a first CORESET or a first SS set associated with the HD mode, and at least one of a second CORESET or a second SS set associated with the FD mode. In some aspects, the configuration information may indicate one or more first TCI states and/or one or more first spatial filters associated with the HD mode, and one or more second TCI states and/or one or more second spatial filters associated with the FD mode. In such aspects, the UE 120 may be configured to transmit and/or receive communications according to the corresponding TCI state and/or spatial filter when the corresponding duplex mode (e.g., HD or FD) is activated.

The UE 120 may configure itself based at least in part on the configuration information. In some aspects, the UE 120 may be configured to perform one or more operations described herein based at least in part on the configuration information.

As shown by reference numbers 610 and 615, in some aspects the network node 110 and the UE 120 may operate in an FD mode. More particularly, the network node 110 and/or the UE 120 may operate in the FD mode by applying one or more FD configuration parameters, such as one or more of the FD configuration parameters described above in connection with reference number 605.

As shown by reference number 620, in some aspects the UE 120 may transmit, and the network node 110 may receive, an indication that a PUSCH occasion that at least partially overlaps with resources associated with a downlink communication (shown in FIG. 6 as PUSCH occasion 625) will not be used to transmit an uplink transmission. Put another way, when the UE 120 is not going to use a PUSCH occasion associated with an FD set of symbols, the UE 120 may inform the network node 110 that the PUSCH occasion 625 will not be used for uplink transmission. In this way, the network node 110 and/or the UE 120 may switch to an HD mode to communicate the downlink channel and/or signal for better performance in the downlink communication. Conversely, if the UE 120 does intend to use a PUSCH occasion 625 that collides with a downlink channel and/or signal, the UE 120 may refrain from transmitting the indication described in connection with reference number 620, and thus the network node 110 may assume that the FD mode should be used for the downlink communication (which, as described above, may not be optimal for the downlink channel and/or signal performance).

In some aspects, the UE 120 may transmit the indication described in connection with reference number 620 in a physical uplink control channel (PUCCH) and/or a PUSCH occurring prior to the PUSCH occasion 625. Additionally, or alternatively, the UE 120 may transmit the indication described in connection with reference number 620 when the UE 120 does not have uplink data to transmit. In some aspects, the indication described in connection with reference number 620 may indicate that UE 120 will not transmit an uplink transmission on the next uplink occasion (e.g., the next PUSCH occasion) after the signaling. Additionally, or alternatively, the indication described in connection with reference number 620 may indicate an offset and/or may be associated with a pre-configured offset (e.g., an offset indicated via the configuration information described above in connection with reference number 605). In such aspects, the indication described in connection with reference number 620 may indicate that UE 120 will not transmit an uplink transmission the indicated uplink occasion (e.g., PUSCH occasion 625) based on the offset indicated in the signaling and/or based on the pre-configured offset. In some other aspects, the indication described in connection with reference number 620 may indicate that UE 120 will not transmit uplink transmissions on more than one uplink occasions (e.g., more than one PUSCH occasions). For example, the indication described in connection with reference number 620 may indicate a bitmap indicating which uplink occasions will not be used (e.g., each bit in the bitmap may be associated with an uplink occasion, and thus the UE 120 may use one of bit “0” or bit “1” to indicate the uplink occasions after the signaling that will not be used for uplink transmissions). Additionally, or alternatively, the indication described in connection with reference number 620 may further indicate a value indicating how many consecutive uplink occasions after the signaling will not be used for uplink transmissions.

Additionally, or alternatively, the PUSCH occasion 625 that at least partially overlaps with the resources associated with the downlink communication may be associated with a CG period associated with one or more PUSCH occasions (e.g., the PUSCH occasion 625 may correspond to a CG PUSCH occasion). In some other aspects, the PUSCH occasion 625 may be associated with a pre-configured dynamic grant scheduled PUSCH. In some other aspects, the PUSCH occasion 625 may be associated with multiple PUSCHs scheduled by a single physical downlink control channel (PDCCH) communication. In some aspects, based at least in part on the network node 110 receiving the indication from the UE 120, the network node may skip decoding signaling in the PUSCH occasion 625.

As shown by reference numbers 630 and 635, the network node 110 and/or the UE 120 may switch from operating in an FD mode to operating in an HD mode based at least in part on the indication. More particularly, the network node 110 and/or the UE 120 may optimize a duplex mode determination when an uplink transmission does not occur in the PUSCH occasion 625 (e.g., when the UE 120 does not have data to transmit) such that the actual operation of the UE 120 and/or the network node 110 within the set of symbols corresponding to the PUSCH occasion 625 (e.g., during the set of symbols used to transmit the downlink communication) is HD instead of FD, notwithstanding that the set of symbols were initially configured and/or scheduled as FD symbols. This may improve performance of the UE 120 and/or the network node 110, reduce resource consumption at the UE 120 and/or the network node 110, and/or reduce communication errors between the UE 120 and/or the network node 110 in the downlink communication.

More particularly, as shown by reference number 640, the network node 110 may transmit, and the UE 120 may receive, the downlink communication while the network node 110 and/or the UE 120 are operating in the HD mode. In some aspects, operating in the HD mode may include the network node 110 adjusting a transmit power associated with the downlink communication based at least in part on receiving the indication. Put another way, in some aspects, operating in the HD mode may include the network node 110 conserving power resources based at least in part on the UE's signaling, such as by reducing a transmit power level when the network node 110 receives the indication from the UE 120.

In some aspects, based at least in part on receiving the indication from the UE 120, the network node 110 may explicitly signal to the UE 120 which mode should be used for reception of the downlink communication (e.g., the network node 110 may expressly indicate that the downlink communication will be transmitted using the HD mode), while, in some other aspects, the mode that is to be used for reception of the downlink communication may be implicitly indicated to the UE 120 based at least in part on the transmission of the indication.

For example, in some aspects, the downlink communication may be associated with a dynamically scheduled downlink communication, such as a dynamically scheduled physical downlink shared channel (PDSCH) communication, a dynamically scheduled channel state information (CSI) reference signal (CSI-RS) communication, or a similar communication. In such aspects, DCI scheduling the downlink communication may include a duplex mode indicator, and thus the duplex mode indicator may indicate the HD mode (e.g., the duplex mode indicator may indicate that the downlink communication is to be received using the HD mode). In such aspects, the UE 120 may switch from operating in the FD mode to operating in the HD mode based at least in part on the duplex mode indicator indicating the HD mode.

In some other aspects, the UE 120 may identify that the HD mode is to be used without explicit signaling from the network node 110. For example, when the downlink communication is a dynamically scheduled communication (e.g., a dynamically scheduled PDSCH communication, CSI-RS communication, or similar communication) that is scheduled by DCI that does not include a duplex mode indicator, the UE 120 may assume that the duplex mode is the HD mode (e.g., the UE 120 may identify that the downlink communication is to be received while operating in the HD mode based at least in part on the UE 120 transmitting the indication). Similarly, when the downlink communication is associated with an SPS downlink communication (e.g., an SPS PDSCH communication, an SPS CSI-RS communication, or a similar communication), the UE 120 may assume that the duplex mode is the HD mode (e.g., the UE 120 may identify that the downlink communication is to be received while operating in the HD mode based at least in part on the UE 120 transmitting the indication).

Moreover, for purposes of downlink control signal monitoring (e.g., PDCCH monitoring), the UE 120 may assume that an HD mode is to be used and/or that HD-specific parameters are to be monitored based at least in part on the UE 120 transmitting the indication. More particularly, in aspects in which the downlink communication is associated with a PDCCH communication, the UE 120 may identify that the PDCCH communication is to be received while operating in the HD mode based at least in part on the UE 120 transmitting the indication. Moreover, the UE may monitor an HD-specific CORESET and/or SS set based at least in part on transmitting the indication.

More particularly, in aspects in which the UE 120 receives a configuration of at least one of a first CORESET or a first SS set associated with the HD mode and at least one of a second CORESET or a second SS set associated with the FD mode (e.g., via the configuration information described above in connection with reference number 605), the network node 110 may transmit, to the UE 120, downlink control signaling using the at least one of the first CORESET or the first SS set based at least in part on receiving the indication, and/or the UE 120 may monitor control signaling using the at least one of the first CORESET or the first SS set based at least in part on transmitting the indication.

In some aspects, operating in the HD mode may include the network node 110 transmitting and/or the UE 120 receiving the downlink communication using a BWP associated with the HD mode. For example, the UE 120 may use a configured reception BWP associated with the HD mode for receiving the downlink communication.

Additionally, or alternatively, operating in the HD mode may include the network node 110 transmitting and/or the UE 120 receiving the downlink communication using a timing advance value associated with the HD mode. Additionally, or alternatively, operating in the HD mode may include the network node 110 transmitting and/or the UE 120 receiving the downlink communication using an SCS associated with the HD mode. Additionally, or alternatively, operating in the HD mode may include the network node 110 transmitting and/or the UE 120 receiving the downlink communication using a polarization mode associated with the HD mode. For example, for line-of-sight communication environments, polarization may be used to multiplex different UE's communications or uplink transmission and downlink reception of the same UE in the FD mode, and thus a different polarization technique may be employed when operating in an HD mode than when operating in an FD mode.

Additionally, or alternatively, operating in the HD mode may include the UE 120 identifying and/or calculating CSI without measuring SI. That is, as described above in connection with FIGS. 4 and 5, operating in an FD mode may result in SI that may be accounted for at the UE 120, such as by estimating the SI from the reception branch at the UE 120. In some aspects, accounting for the SI by the UE 120 (e.g., estimating the SI from the reception branch at the UE 120) may be omitted when operating in the HD mode. Additionally, or alternatively, operating in the HD mode may include the network node 110 transmitting and/or the UE 120 receiving the downlink communication using an entire bandwidth in a symbol or slot configured for an SBFD operation. Put another way, in aspects in which the UE 120 is configured to operate in SBFD with respect to the set of symbols corresponding to the PUSCH occasion 625 (e.g., when the UE 120 is configured to transmit uplink communications using one or more subbands of a carrier bandwidth and receive downlink communications using one or more other subbands of the carrier bandwidth), when the UE 120 switches to the HD mode and/or skips the PUSCH occasion 625, the UE 120 may assume that the entire bandwidth is now available for downlink reception.

Moreover, as described above in connection with FIGS. 4A-4C, in some aspects operating in an FD mode and/or an HD mode may result in CLI. Accordingly, the UE 120 may be configured to measure CLI, such as for purposes of measuring inter-UE interference caused by an aggressor UE's transmission received by a victim UE (as described above in connection with example 410, with the second UE 402-2 corresponding to the aggressor UE and the first UE 402-1 corresponding to the victim UE). In such aspects, a reception beam used for CLI measurement may correspond to a reception beam associated with the latest serving cell channel (e.g., the latest PDSCH or PDCCH). Accordingly, when the network node 110 and/or the UE 120 switch to the HD mode in response to the indication, the UE 120 may perform a CLI measurement using a latest spatial QCL associated with a serving cell downlink reception in the HD mode. Put another way, the UE 120 may measure a CLI measurement resource during the skipped PUSCH occasion 625 in the latest spatial QCL that is used for serving cell PDSCH or PDCCH reception in the HD mode.

As indicated by reference number 645, the UE 120 may be configured, pre-configured, and/or hard coded with a time threshold (e.g., a minimum time period) associated with switching from the FD mode to the HD mode. In such aspects, the network node 110 and/or the UE 120 switching from operating in the FD mode to operating in the HD mode may be based at least in part in part on the UE 120 transmitting, and/or the network node 110 receiving, the indication at least the time threshold prior to the PUSCH occasion 625 and/or the downlink communication. Put another way, in some aspects, if the UE 120 transmits, and/or the network node 110 receives, the indication at least the time threshold prior to the PUSCH occasion 625 and/or the downlink communication, the network node 110 and the UE 120 may have sufficient time to switch from the FD mode to the HD mode, thus may perform the switching (as described above in connection with reference numbers 630 and 635). On the other hand, if the UE 120 transmits, and/or the network node 110 receives, the indication less than the time threshold prior to the PUSCH occasion 625 and/or the downlink communication, the network node 110 and/or the UE 120 may not have sufficient time to switch from the FD mode to the HD mode, thus the downlink communication may be communicated while the network node 110 and/or the UE 120 are operating in the FD mode (e.g., the network node 110 and the UE 120 may continue to operate in the FD mode during a set of symbols notwithstanding that only the downlink communication, and not an uplink communication, is communicated during the set of symbols).

In some aspects, the time threshold may be associated with a quantity of milliseconds (ms), a quantity of slots, or a quantity of symbols. More particularly, the time threshold may be defined as a minimum number of ms, slots, or symbols between the indication and the PUSCH occasion 625 and/or the downlink communication that must be accounted for in order to enable duplex mode switching. Additionally, or alternatively, the time threshold may be associated with a gap between an end of the indication and a start of the PUSCH occasion 625 and/or a start of the downlink communication. In that regard, if the gap between the end of the indication and a start of the PUSCH occasion 625 and/or the downlink communication is larger than the time threshold, the UE 120 may assume that the downlink communication will be transmitted using the HD mode, and thus the UE 120 may correspondingly switch to operating in the HD mode. In some aspects, the time threshold may apply for purposes of downlink signals and/or channels as well as CLI measurement purposes, while, in some other aspects, CLI measurement may not be associated with the time threshold (e.g., the UE 120 may perform a CLI measurement using a latest spatial QCL associated with a serving cell downlink reception in the HD mode notwithstanding that the indication was transmitted by the UE 120 less than the time threshold prior to the PUSCH occasion 625 and/or the downlink communication).

Based at least in part on the UE 120 and/or the network node 110 performing duplex mode switching based at least in part on an indication of a skipped uplink occasion, the UE 120 and/or the network node 110 may conserve computing, power, network, and/or communication resources for the downlink communication that may have otherwise been consumed operating in a FD mode within uplink occasions in which the UE 120 has no data to transmit. For example, based at least in part on the UE 120 and/or the network node 110 performing duplex mode switching based at least in part on an indication of a skipped uplink occasion, the UE 120 and the network node 110 may communicate with a reduced error rate, which may conserve computing, power, network, and/or communication resources for the downlink communication that may have otherwise been consumed to detect and/or correct communication errors.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 120) performs operations associated with duplex mode switching based at least in part on an indication of a skipped uplink occasion.

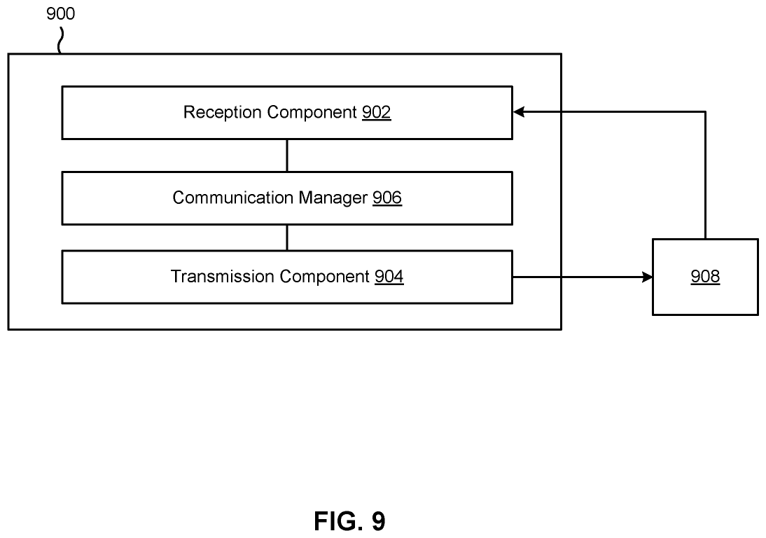

As shown in FIG. 7, in some aspects, process 700 may include transmitting an indication that a PUSCH occasion that at least partially overlaps with resources associated with a downlink communication will not be used to transmit an uplink transmission (block 710). For example, the UE (e.g., using transmission component 904 and/or communication manager 906, depicted in FIG. 9) may transmit an indication that a PUSCH occasion that at least partially overlaps with resources associated with a downlink communication will not be used to transmit an uplink transmission, as described above.

As further shown in FIG. 7, in some aspects, process 700 may include switching from operating in an FD mode to operating in an HD mode based at least in part on transmitting the indication (block 720). For example, the UE (e.g., using communication manager 906, depicted in FIG. 9) may switch from operating in an FD mode to operating in an HD mode based at least in part on transmitting the indication, as described above.

As further shown in FIG. 7, in some aspects, process 700 may include receiving the downlink communication while operating in the HD mode (block 730).

For example, the UE (e.g., using reception component 902 and/or communication manager 906, depicted in FIG. 9) may receive the downlink communication while operating in the HD mode, as described above.

Process 700 may include additional aspects, such as any single aspect or any combination of aspects described below and/or in connection with one or more other processes described elsewhere herein.

In a first aspect, process 700 includes receiving DCI scheduling the downlink communication, wherein the DCI includes a duplex mode indicator, wherein the duplex mode indicator indicates the HD mode, and wherein switching from operating in the FD mode to operating in the HD mode is further based at least in part on the duplex mode indicator.

In a second aspect, alone or in combination with the first aspect, process 700 includes receiving DCI scheduling the downlink communication, wherein the DCI does not include a duplex mode indicator, and wherein the UE identifies that the downlink communication is to be received while operating in the HD mode based at least in part on transmitting the indication.

In a third aspect, alone or in combination with one or more of the first and second aspects, the downlink communication is associated with an SPS downlink communication, and the UE identifies that the downlink communication is to be received while operating in the HD mode based at least in part on transmitting the indication.

In a fourth aspect, alone or in combination with one or more of the first through third aspects, the downlink communication is associated with a PDCCH communication, and the UE identifies that the PDCCH communication is to be received while operating in the HD mode based at least in part on transmitting the indication.

In a fifth aspect, alone or in combination with one or more of the first through fourth aspects, process 700 includes receiving a configuration of at least one of a first CORESET or a first SS set associated with the HD mode, and at least one of a second CORESET or a second SS set associated with the FD mode, and monitoring control signaling using the at least one of the first CORESET or the first SS set based at least in part on receiving the indication.

In a sixth aspect, alone or in combination with one or more of the first through fifth aspects, operating in the HD mode includes at least one of receiving the downlink communication using a bandwidth part associated with the HD mode, receiving the downlink communication using a timing advance value associated with the HD mode, receiving the downlink communication using a subcarrier spacing associated with the HD mode, receiving the downlink communication using a polarization mode associated with the HD mode, identifying channel state information without measuring self-interference, or receiving the downlink communication using an entire bandwidth associated with a subband FD operation.

In a seventh aspect, alone or in combination with one or more of the first through sixth aspects, process 700 includes performing a cross-link interference measurement using a latest spatial quasi co-location associated with a serving cell downlink reception in the HD mode.

In an eighth aspect, alone or in combination with one or more of the first through seventh aspects, process 700 includes switching from operating in the FD mode to operating in the HD mode based at least in part in part on transmitting the indication at least a time threshold prior to at least one of the PUSCH occasion or the downlink communication.

In a ninth aspect, alone or in combination with one or more of the first through eighth aspects, the time threshold is associated with at least one of a quantity of milliseconds, a quantity of slots, or a quantity of symbols.

In a tenth aspect, alone or in combination with one or more of the first through ninth aspects, the time threshold is associated with a gap between an end of the indication and a start of the PUSCH occasion.

In an eleventh aspect, alone or in combination with one or more of the first through tenth aspects, the time threshold is associated with a gap between an end of the indication and a start of the downlink communication.

In a twelfth aspect, alone or in combination with one or more of the first through eleventh aspects, the PUSCH occasion is associated with at least one of a configured grant period associated with one or more PUSCH occasions, a pre-configured dynamic grant scheduled PUSCH, or multiple PUSCHs scheduled by a single physical downlink control channel communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with duplex mode switching based at least in part on an indication of a skipped uplink occasion.

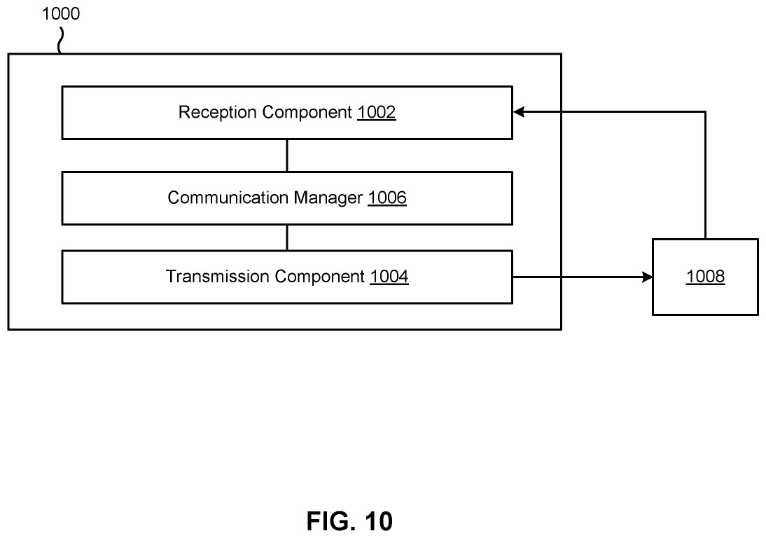

As shown in FIG. 8, in some aspects, process 800 may include receiving, from a UE, an indication that a PUSCH occasion that at least partially overlaps with resources associated with a downlink communication will not be used to transmit an uplink transmission (block 810). For example, the network node (e.g., using reception component 1002 and/or communication manager 1006, depicted in FIG. 10) may receive, from a UE, an indication that a PUSCH occasion that at least partially overlaps with resources associated with a downlink communication will not be used to transmit an uplink transmission, as described above.

As further shown in FIG. 8, in some aspects, process 800 may include switching from operating in an FD mode to operating in an HD mode based at least in part on receiving the indication (block 820). For example, the network node (e.g., using communication manager 1006, depicted in FIG. 10) may switch from operating in an FD mode to operating in an HD mode based at least in part on receiving the indication, as described above.

As further shown in FIG. 8, in some aspects, process 800 may include transmitting, to the UE, the downlink communication while operating in the HD mode (block 830). For example, the network node (e.g., using transmission component 1004 and/or communication manager 1006, depicted in FIG. 10) may transmit, to the UE, the downlink communication while operating in the HD mode, as described above.

Process 800 may include additional aspects, such as any single aspect or any combination of aspects described below and/or in connection with one or more other processes described elsewhere herein.

In a first aspect, process 800 includes adjusting a transmit power associated with the downlink communication based at least in part on receiving the indication.

In a second aspect, alone or in combination with the first aspect, process 800 includes transmitting, to the UE, DCI scheduling the downlink communication, wherein the DCI includes a duplex mode indicator, and wherein network node sets the duplex mode indicator to the HD mode based at least in part on receiving the indication.

In a third aspect, alone or in combination with one or more of the first and second aspects, process 800 includes transmitting, to the UE, a configuration of at least one of a first CORESET or a first SS set associated with the HD mode, and at least one of a second CORESET or a second SS set associated with the FD mode, and transmitting, to the UE, control signaling using the at least one of the first CORESET or the first SS set based at least in part on receiving the indication.

In a fourth aspect, alone or in combination with one or more of the first through third aspects, operating in the HD mode includes at least one of transmitting the downlink communication using a bandwidth part associated with the HD mode, transmitting the downlink communication using a subcarrier spacing associated with the HD mode, transmitting the downlink communication using a polarization mode associated with the HD mode, transmitting the downlink communication using an entire bandwidth associated with a subband FD operation.

In a fifth aspect, alone or in combination with one or more of the first through fourth aspects, process 800 includes switching from operating in the FD mode to operating in the HD mode based at least in part in part on receiving the indication at least a time threshold prior to at least one of the PUSCH occasion or the downlink communication.

In a sixth aspect, alone or in combination with one or more of the first through fifth aspects, the time threshold is associated with at least one of a quantity of milliseconds, a quantity of slots, or a quantity of symbols.

In a seventh aspect, alone or in combination with one or more of the first through sixth aspects, the time threshold is associated with a gap between an end of the indication and a start of the PUSCH occasion.

In an eighth aspect, alone or in combination with one or more of the first through seventh aspects, the time threshold is associated with a gap between an end of the indication and a start of the downlink communication.

In a ninth aspect, alone or in combination with one or more of the first through eighth aspects, the PUSCH occasion is associated with at least one of a configured grant period associated with one or more PUSCH occasions, a pre-configured dynamic grant scheduled PUSCH, or multiple PUSCHs scheduled by a single physical downlink control channel communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE 120 described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE 120 described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE 120 described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an indication that a PUSCH occasion that at least partially overlaps with resources associated with a downlink communication will not be used to transmit an uplink transmission. The communication manager 906 may switch from operating in an FD mode to operating in an HD mode based at least in part on transmitting the indication. The reception component 902 may receive the downlink communication while operating in the HD mode.

The reception component 902 may receive DCI scheduling the downlink communication, wherein the DCI includes a duplex mode indicator, wherein the duplex mode indicator indicates the HD mode, and wherein switching from operating in the FD mode to operating in the HD mode is further based at least in part on the duplex mode indicator.

The reception component 902 may receive DCI scheduling the downlink communication, wherein the DCI does not include a duplex mode indicator, and wherein the UE identifies that the downlink communication is to be received while operating in the HD mode based at least in part on transmitting the indication.

The reception component 902 may receive a configuration of at least one of a first CORESET or a first SS set associated with the HD mode, and at least one of a second CORESET or a second SS set associated with the FD mode.

The communication manager 906 may monitor control signaling using the at least one of the first CORESET or the first SS set based at least in part on receiving the indication.

The communication manager 906 may perform a cross-link interference measurement using a latest spatial quasi co-location associated with a serving cell downlink reception in the HD mode.

The communication manager 906 may switch from operating in the FD mode to operating in the HD mode based at least in part in part on transmitting the indication at least a time threshold prior to at least one of the PUSCH occasion or the downlink communication.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node 110 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node 110 described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node 110 described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a UE, an indication that a PUSCH occasion that at least partially overlaps with resources associated with a downlink communication will not be used to transmit an uplink transmission. The communication manager 1006 may switch from operating in an FD mode to operating in an HD mode based at least in part on receiving the indication. The transmission component 1004 may transmit, to the UE, the downlink communication while operating in the HD mode.

The communication manager 1006 may adjust a transmit power associated with the downlink communication based at least in part on receiving the indication.

The transmission component 1004 may transmit, to the UE, DCI scheduling the downlink communication, wherein the DCI includes a duplex mode indicator, and wherein network node sets the duplex mode indicator to the HD mode based at least in part on receiving the indication.

The transmission component 1004 may transmit, to the UE, a configuration of at least one of a first CORESET or a first SS set associated with the HD mode, and at least one of a second CORESET or a second SS set associated with the FD mode.

The transmission component 1004 may transmit, to the UE, control signaling using the at least one of the first CORESET or the first SS set based at least in part on receiving the indication.

The communication manager 1006 may switch from operating in the FD mode to operating in the HD mode based at least in part in part on receiving the indication at least a time threshold prior to at least one of the PUSCH occasion or the downlink communication.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a UE, comprising: transmitting an indication that a PUSCH occasion that at least partially overlaps with resources associated with a downlink communication will not be used to transmit an uplink transmission; switching from operating in an FD mode to operating in an HD mode based at least in part on transmitting the indication; and receiving the downlink communication while operating in the HD mode.

Aspect 2: The method of Aspect 1, further comprising receiving DCI scheduling the downlink communication, wherein the DCI includes a duplex mode indicator, wherein the duplex mode indicator indicates the HD mode, and wherein switching from operating in the FD mode to operating in the HD mode is further based at least in part on the duplex mode indicator.

Aspect 3: The method of Aspect 1, further comprising receiving DCI scheduling the downlink communication, wherein the DCI does not include a duplex mode indicator, and wherein the UE identifies that the downlink communication is to be received while operating in the HD mode based at least in part on transmitting the indication.

Aspect 4: The method of Aspect 1, wherein the downlink communication is associated with an SPS downlink communication, and wherein the UE identifies that the downlink communication is to be received while operating in the HD mode based at least in part on transmitting the indication.

Aspect 5: The method of Aspect 1, wherein the downlink communication is associated with a PDCCH communication, and wherein the UE identifies that the PDCCH communication is to be received while operating in the HD mode based at least in part on transmitting the indication.

Aspect 6: The method of any of Aspects 1-5, further comprising: receiving a configuration of at least one of a first CORESET or a first SS set associated with the HD mode, and at least one of a second CORESET or a second SS set associated with the FD mode; and monitoring control signaling using the at least one of the first CORESET or the first SS set based at least in part on receiving the indication.

Aspect 7: The method of any of Aspects 1-6, wherein operating in the HD mode includes at least one of: receiving the downlink communication using a bandwidth part associated with the HD mode, receiving the downlink communication using a timing advance value associated with the HD mode, receiving the downlink communication using a subcarrier spacing associated with the HD mode, receiving the downlink communication using a polarization mode associated with the HD mode, identifying channel state information without measuring self-interference, or receiving the downlink communication using an entire bandwidth associated with a subband FD operation.

Aspect 8: The method of any of Aspects 1-7, further comprising performing a cross-link interference measurement using a latest spatial quasi co-location associated with a serving cell downlink reception in the HD mode.

Aspect 9: The method of any of Aspects 1-8, further comprising switching from operating in the FD mode to operating in the HD mode based at least in part in part on transmitting the indication at least a time threshold prior to at least one of the PUSCH occasion or the downlink communication.

Aspect 10: The method of Aspect 9, wherein the time threshold is associated with at least one of: a quantity of milliseconds, a quantity of slots, or a quantity of symbols.

Aspect 11: The method of any of Aspects 9-10, wherein the time threshold is associated with a gap between an end of the indication and a start of the PUSCH occasion.

Aspect 12: The method of any of Aspects 9-10, wherein the time threshold is associated with a gap between an end of the indication and a start of the downlink communication.

Aspect 13: The method of any of Aspects 1-12, wherein the PUSCH occasion is associated with at least one of: a configured grant period associated with one or more PUSCH occasions, a pre-configured dynamic grant scheduled PUSCH, or multiple PUSCHs scheduled by a single physical downlink control channel communication.

Aspect 14: A method of wireless communication performed by a network node, comprising: receiving, from a UE, an indication that a PUSCH occasion that at least partially overlaps with resources associated with a downlink communication will not be used to transmit an uplink transmission; switching from operating in an FD mode to operating in an HD mode based at least in part on receiving the indication; and transmitting, to the UE, the downlink communication while operating in the HD mode.

Aspect 15: The method of Aspect 14, further comprising adjusting a transmit power associated with the downlink communication based at least in part on receiving the indication.

Aspect 16: The method of any of Aspects 14-15, further comprising transmitting, to the UE, DCI scheduling the downlink communication, wherein the DCI includes a duplex mode indicator, and wherein network node sets the duplex mode indicator to the HD mode based at least in part on receiving the indication.

Aspect 17: The method of any of Aspects 14-16, further comprising: transmitting, to the UE, a configuration of at least one of a first CORESET or a first SS set associated with the HD mode, and at least one of a second CORESET or a second SS set associated with the FD mode; and transmitting, to the UE, control signaling using the at least one of the first CORESET or the first SS set based at least in part on receiving the indication.

Aspect 18: The method of any of Aspects 14-17, wherein operating in the HD mode includes at least one of: transmitting the downlink communication using a bandwidth part associated with the HD mode, transmitting the downlink communication using a subcarrier spacing associated with the HD mode, transmitting the downlink communication using a polarization mode associated with the HD mode, transmitting the downlink communication using an entire bandwidth associated with a subband FD operation.

Aspect 19: The method of any of Aspects 14-18, further comprising switching from operating in the FD mode to operating in the HD mode based at least in part in part on receiving the indication at least a time threshold prior to at least one of the PUSCH occasion or the downlink communication.

Aspect 20: The method of Aspect 19, wherein the time threshold is associated with at least one of: a quantity of milliseconds, a quantity of slots, or a quantity of symbols.

Aspect 21: The method of any of Aspects 19-20, wherein the time threshold is associated with a gap between an end of the indication and a start of the PUSCH occasion.

Aspect 22: The method of any of Aspects 19-20, wherein the time threshold is associated with a gap between an end of the indication and a start of the downlink communication.

Aspect 23: The method of any of Aspects 14-22, wherein the PUSCH occasion is associated with at least one of: a configured grant period associated with one or more PUSCH occasions, a pre-configured dynamic grant scheduled PUSCH, or multiple PUSCHs scheduled by a single physical downlink control channel communication.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
transmit an indication that a physical uplink shared channel (PUSCH) occasion that at least partially overlaps with resources associated with a downlink communication will not be used to transmit an uplink transmission;
switch from operating in a full duplex (FD) mode to operating in a half duplex (HD) mode based at least in part on transmitting the indication; and
receive the downlink communication while operating in the HD mode.

2. The UE of claim 1, wherein the one or more processors are further configured to receive downlink control information (DCI) scheduling the downlink communication, wherein the DCI includes a duplex mode indicator, wherein the duplex mode indicator indicates the HD mode, and wherein switching from operating in the FD mode to operating in the HD mode is further based at least in part on the duplex mode indicator.

3. The UE of claim 1, wherein the one or more processors are further configured to receive downlink control information (DCI) scheduling the downlink communication, wherein the DCI does not include a duplex mode indicator, and wherein the UE identifies that the downlink communication is to be received while operating in the HD mode based at least in part on transmitting the indication.

4. The UE of claim 1, wherein the downlink communication is associated with a semi-persistent scheduling (SPS) downlink communication, and wherein the one or more processors are further configured to identify that the downlink communication is to be received while operating in the HD mode based at least in part on transmitting the indication.

5. The UE of claim 1, wherein the downlink communication is associated with a physical downlink control channel (PDCCH) communication, and wherein the one or more processors are further configured to identify that the PDCCH communication is to be received while operating in the HD mode based at least in part on transmitting the indication.

6. The UE of claim 1, wherein the one or more processors are further configured to:
receive a configuration of at least one of a first control resource set (CORESET) or a first search space (SS) set associated with the HD mode, and at least one of a second CORESET or a second SS set associated with the FD mode; and
monitor control signaling using the at least one of the first CORESET or the first SS set based at least in part on receiving the indication.

7. The UE of claim 1, wherein the one or more processors, to operate in the HD mode, are configured to:
receive the downlink communication using a bandwidth part associated with the HD mode,
receive the downlink communication using a timing advance value associated with the HD mode,
receive the downlink communication using a subcarrier spacing associated with the HD mode,
receive the downlink communication using a polarization mode associated with the HD mode,
identify channel state information without measuring self-interference, or
receive the downlink communication using an entire bandwidth associated with a subband FD operation.

8. The UE of claim 1, wherein the one or more processors are further configured to perform a cross-link interference measurement using a latest spatial quasi co-location associated with a serving cell downlink reception in the HD mode.

9. The UE of claim 1, wherein the one or more processors are further configured to switch from operating in the FD mode to operating in the HD mode based at least in part in part on transmitting the indication at least a time threshold prior to at least one of the PUSCH occasion or the downlink communication.

10. The UE of claim 9, wherein the time threshold is associated with at least one of:
a quantity of milliseconds,
a quantity of slots, or
a quantity of symbols.

11. The UE of claim 9, wherein the time threshold is associated with a gap between an end of the indication and a start of the PUSCH occasion.

12. The UE of claim 9, wherein the time threshold is associated with a gap between an end of the indication and a start of the downlink communication.

13. The UE of claim 1, wherein the PUSCH occasion is associated with at least one of:
a configured grant period associated with one or more PUSCH occasions,
a pre-configured dynamic grant scheduled PUSCH, or
multiple PUSCHs scheduled by a single physical downlink control channel communication.

14. A network node for wireless communication, comprising:
a memory; and
one or more processors, coupled to the memory, configured to:
receive, from a user equipment (UE), an indication that a physical uplink shared channel (PUSCH) occasion that at least partially overlaps with resources associated with a downlink communication will not be used to transmit an uplink transmission;
switch from operating in a full duplex (FD) mode to operating in a half duplex (HD) mode based at least in part on receiving the indication; and
transmit, to the UE, the downlink communication while operating in the HD mode.

15. The network node of claim 14, wherein the one or more processors are further configured to adjust a transmit power associated with the downlink communication based at least in part on receiving the indication.

16. The network node of claim 14, wherein the one or more processors are further configured to transmit, to the UE, downlink control information (DCI) scheduling the downlink communication, wherein the DCI includes a duplex mode indicator, and wherein network node sets the duplex mode indicator to the HD mode based at least in part on receiving the indication.

17. The network node of claim 14, wherein the one or more processors are further configured to:
transmit, to the UE, a configuration of at least one of a first control resource set (CORESET) or a first search space (SS) set associated with the HD mode, and at least one of a second CORESET or a second SS set associated with the FD mode; and
transmit, to the UE, control signaling using the at least one of the first CORESET or the first SS set based at least in part on receiving the indication.

18. The network node of claim 14, wherein the one or more processors, to operate in the HD mode, are configured to:
transmit the downlink communication using a bandwidth part associated with the HD mode,
transmit the downlink communication using a subcarrier spacing associated with the HD mode,
transmit the downlink communication using a polarization mode associated with the HD mode,
transmit the downlink communication using an entire bandwidth associated with a subband FD operation.

19. The network node of claim 14, wherein the one or more processors are further configured to switch from operating in the FD mode to operating in the HD mode based at least in part in part on receiving the indication at least a time threshold prior to at least one of the PUSCH occasion or the downlink communication.

20. The network node of claim 19, wherein the time threshold is associated with at least one of:
a quantity of milliseconds,
a quantity of slots, or
a quantity of symbols.

21. The network node of claim 19, wherein the time threshold is associated with a gap between an end of the indication and a start of the PUSCH occasion.

22. The network node of claim 19, wherein the time threshold is associated with a gap between an end of the indication and a start of the downlink communication.

23. The network node of claim 14, wherein the PUSCH occasion is associated with at least one of:
a configured grant period associated with one or more PUSCH occasions,
a pre-configured dynamic grant scheduled PUSCH, or
multiple PUSCHs scheduled by a single physical downlink control channel communication.

24. A method of wireless communication performed by a user equipment (UE), comprising:
transmitting an indication that a physical uplink shared channel (PUSCH) occasion that at least partially overlaps with resources associated with a downlink communication will not be used to transmit an uplink transmission;
switching from operating in a full duplex (FD) mode to operating in a half duplex (HD) mode based at least in part on transmitting the indication; and
receiving the downlink communication while operating in the HD mode.

25. The method of claim 24, further comprising switching from operating in the FD mode to operating in the HD mode based at least in part in part on transmitting the indication at least a time threshold prior to at least one of the PUSCH occasion or the downlink communication.

26. The method of claim 25, wherein the time threshold is associated with at least one of:
a quantity of milliseconds,
a quantity of slots, or
a quantity of symbols.

27. The method of claim 25, wherein the time threshold is associated with a gap between an end of the indication and at least one of a start the PUSCH occasion or a start of the downlink communication.

28. A method of wireless communication performed by a network node, comprising:
receiving, from a user equipment (UE), an indication that a physical uplink shared channel (PUSCH) occasion that at least partially overlaps with resources associated with a downlink communication will not be used to transmit an uplink transmission;
switching from operating in a full duplex (FD) mode to operating in a half duplex (HD) mode based at least in part on receiving the indication; and
transmitting, to the UE, the downlink communication while operating in the HD mode.

29. The method of claim 28, further comprising switching from operating in the FD mode to operating in the HD mode based at least in part in part on receiving the indication at least a time threshold prior to at least one of the PUSCH occasion or the downlink communication.

30. The method of claim 29, wherein the time threshold is associated with a gap between an end of the indication and at least one of a start of the PUSCH occasion or a start of the downlink communication.
